(19) United States
(12) Patent Application Publication
(10) Pub. No.: US 2025/0343271 A1
(43) Pub. Date: Nov. 6, 2025

(54) Liquid Electrolytes Comprising Ionic Liquids for Lithium-Metal Battery Modules

(71) Applicant: Cuberg, Inc., San Leandro, CA (US)

(72) Inventors: Michael McEldrew, San Leandro, CA (US); Dylan Bauer, San Leandro, CA (US); Sanjay Nanda, San Francisco, CA (US); Aaron Garg, San Leandro, CA (US); Michelle Chen, Berkeley, CA (US); Jack Fawdon, San Leandro, CA (US)

(73) Assignee: Cuberg, Inc., San Leandro, CA (US)

(21) Appl. No.: 18/654,679

(22) Filed: May 3, 2024

(51) Int. Cl. H01M 10/0569; H01M 10/052; H01M 10/0567; H01M 10/0568; H01M 10/42

(52) U.S. Cl. CPC H01M 10/0569; H01M 10/052; H01M 10/0567; H01M 10/0568; H01M 10/4235; H01M 2300/0034; H01M 2300/0037

(57) ABSTRACT

Described herein are lithium-metal rechargeable electrochemical cells comprising a lithium-metal negative electrode, a positive electrode, and a liquid electrolyte. The liquid electrolyte comprises a core mixture and a diluent. The diluent comprises a fluorinated ether. The core mixture comprises a set of salts and a set of solvents. The set of solvents comprises a pyrrolidinium-containing ionic liquid and a molecular solvent. The molecular solvent is a non-fluorinated ether, for example including but not limited to 1,2-dimethoxyethane. In some examples, the electrolyte further comprises an electrolyte additive, for example including but not limited to tris(trimethylsilyl)phosphate. In some examples, the set of salts comprises one or more imide-containing lithium salts. In some examples, the set of salts comprises lithium bis(fluorosulfonyl)imide and an additional salt and the mole fraction of lithium bis(fluorosulfonyl)imide in the set of salts is 0.5 or greater.

### BACKGROUND

Lithium-ion (Li-ion or Lil) cells or, more generally, Li-ion batteries are widely used for various applications. For example, Li-ion batteries are used to power devices as small as medical devices or cell phones and as large as electric vehicles or aircraft. The wide adoption of Li-ion batteries across many industries generated many useful designs and knowledge about fabricating Li-ion battery modules and packs. In particular, many concerns involving cycling efficiency, capacity, and safety have been addressed in Li-ion batteries.

Lithium metal (Li-metal or LiM) cells represent a different battery type and are distinct from Li-ion cells. Specifically, Li-ion cells utilize special negative-electrode active materials (e.g., graphite, silicon) to trap lithium ions when the Li-ion cells are charging. On the other hand, Li-metal cells utilize the direct deposition (e.g., plating) of lithium metal on the negative current collectors without a need for any additional active materials for trapping lithium ions. As such, Li-metal cells tend to have a lower weight and a higher energy density in comparison to Li-ion cells. For example, Li-metal has a specific capacity of 3,860 mAh/g, which is about ten times higher than that of graphite.

However, Li-metal cells or, more generally, Li-metal batteries are currently not widely adopted at the scale of Li-ion batteries. For example, repeated plating and stripping of lithium metal can form a porous lithium structure, which negatively impacts the further performance and cycle life of Li-metal cells. The plating characteristics of lithium metal depend in large part on the electrolyte composition. Ionic liquid-based electrolytes have properties desirable for use in Li-metal electrochemical cells, among the most appealing are that they suppress Cathode Active material degradation. In addition, they are non-flammable. However, most ionic liquids are not reductively stable and therefore suffer low coulombic efficiency when plating/stripping lithium metal. Also, their viscosity may be higher than other solvents. High viscosity leads to the sluggish transport of lithium ions, ultimately limiting charge and discharge rates.

What is needed are new electrolyte formulations and lithium-metal rechargeable electrochemical cells fabricated with these electrolytes that have improved performance.

### SUMMARY

Described herein are lithium-metal rechargeable electrochemical cells comprising a lithium-metal negative electrode, a positive electrode, and a liquid electrolyte. The liquid electrolyte comprises a core mixture and a diluent. The diluent comprises a fluorinated ether. The core mixture comprises a set of salts and a set of solvents. The set of solvents comprises a pyrrolidinium-containing ionic liquid and a molecular solvent. The molecular solvent is a non-fluorinated ether, for example including but not limited to 1,2-dimethoxyethane. In some examples, the electrolyte further comprises an electrolyte additive, for example including but not limited to tris(trimethylsilyl)phosphate. In some examples, the set of salts comprises one or more imide-containing lithium salts. In some examples, the set of salts comprises lithium bis(fluorosulfonyl)imide and an additional salt and the mole fraction of lithium bis(fluorosulfonyl)imide in the set of salts is 0.5 or greater.
Clause 1. A lithium-metal battery electrolyte comprising: a diluent having a formula CF2H—(CF2)n—O—CH2—(CF2)m—CF2H where n and m are each separately 0-3; and a core mixture comprising a set of salts and a set of solvents, wherein: the set of salts comprises a salt having an anion bis(fluorosulfonyl)imide and an additional salt having an anion represented by R—SO2—N—SO2—R′, each of R and R′ is selected from the group consisting of CF3, C2F5, and C3F7, a mole fraction (X3) of the salt in the set of salts in the core mixture is 0.5 or greater, and the set of solvents comprises an ionic liquid and a molecular solvent.
Clause 2. The lithium-metal battery electrolyte of clause 1, wherein a mole fraction (X1) of the core mixture in the lithium-metal battery electrolyte is 0.4-0.99.
Clause 3. The lithium-metal battery electrolyte of clause 1, wherein a mole fraction (X2) of the set of salts in the core mixture is 0.25-0.55.
Clause 4. The lithium-metal battery electrolyte of clause 1, wherein a mole fraction (X4) of the ionic liquid in the set of solvents is 0.01-0.65.
Clause 5. The lithium-metal battery electrolyte of clause 1, wherein the diluent is 1,1,2,2-tetrafluoroethyl-2,2,3,3-tetrafluoropropyl ether (TFPE).
Clause 6. The lithium-metal battery electrolyte of clause 1, wherein each of R and R′ in R—SO2—N—SO2—R′ representing the anion of the additional salt is CF3.
Clause 7. The lithium-metal battery electrolyte of clause 1, wherein the set of salts further comprises a salt having a different composition from the salt and the additional salt and selected from the group consisting of lithium tetrafluoroborate (LiBF4), lithium hexafluorophosphate (LiPF6), lithium bis(oxalato) borate (LiBOB), lithium difluoro (oxalato) borate (LiDFOB), lithium trifluoromethanesulfonate (LiTf), lithium nitrate (LiNO3).
Clause 8. The lithium-metal battery electrolyte of clause 1, wherein the ionic liquid is selected from the group consisting of N-propyl-N-methylpyrrolidinium bis(fluorosulfonyl)imide (Pyr13FSI), N-butyl-N-methylpyrrolidinium bis(fluorosulfonyl)imide (Pyr14FSI), N-pentyl-N-methylpyrrolidinium bis(fluorosulfonyl)imide (Pyr15FSI), N-hexyl-N-methylpyrrolidinium bis(fluorosulfonyl)imide (Pyr16FSI), N-heptyl-N-methylpyrrolidinium bis(fluorosulfonyl)imide (Pyr17FSI), N-octyl-N-methylpyrrolidinium bis(fluorosulfonyl)imide (Pyr18FSI).
Clause 9. The lithium-metal battery electrolyte of clause 1, wherein the ionic liquid comprises N-propyl-N-methylpyrrolidinium bis(fluorosulfonyl)imide (Pyr13FSI) and at least one ionic liquid selected from the group consisting of N-butyl-N-methylpyrrolidinium bis(fluorosulfonyl)imide (Pyr14FSI), N-pentyl-N-methylpyrrolidinium bis(fluorosulfonyl)imide (Pyr15FSI), N-hexyl-N-methylpyrrolidinium bis(fluorosulfonyl)imide (Pyr16FSI), N-heptyl-N-methylpyrrolidinium bis(fluorosulfonyl)imide (Pyr17FSI), N-octyl-N-methylpyrrolidinium bis(fluorosulfonyl)imide (Pyr18FSI), wherein the mole fraction of N-propyl-N-methylpyrrolidinium bis(fluorosulfonyl)imide (Pyr13FSI) in the ionic liquid is greater than 0.75.
Clause 10. The lithium-metal battery electrolyte of clause 1, wherein the molecular solvent is selected from the group consisting of 1,2-dimethoxyethane (DME), 1,2-diethoxyethane (DEE), dimethoxymethane (DMM), 1,3-dimethoxypropane (DMP), dipropylether (DPE), dibutylether (DBE), bis(2-methoxyethyl) ether (G2, diglyme).
Clause 11. The lithium-metal battery electrolyte of clause 1, wherein the molecular solvent comprises 1,2-dimethoxyethane (DME) and another ether selected from the group consisting of, 1,2-diethoxyethane (DEE), dimethoxymethane (DMM), 1,3-dimethoxypropane (DMP), dipropylether (DPE), dibutylether (DBE), bis(2-methoxyethyl) ether (diglyme), wherein the mole fraction of 1,2-dimethoxyethane (DME) in the molecular solvent is greater than 0.75.
Clause 12. The lithium-metal battery electrolyte of clause 1, wherein: a mole fraction (X1) of the core mixture in the lithium-metal battery electrolyte is 0.4-0.99, a mole fraction (X2) of the set of salts in the core mixture is 0.25-0.55, a mole fraction (X3) of the salt in the set of salts is 0.5 or greater, and a mole fraction (X4) of the ionic liquid in the set of solvents is 0.4-0.65.
Clause 13. The lithium-metal battery electrolyte of clause 1, wherein: a mole fraction (X1) of the core mixture in the lithium-metal battery electrolyte is less than 0.65, a mole fraction (X2) of the set of salts in the core mixture is 0.25-0.55, a mole fraction (X3) of the salt in the set of salts is 0.5 or greater, and a mole fraction (X4) of the ionic liquid in the set of solvents is less than 0.3.
Clause 14. The lithium-metal battery electrolyte of clause 1, further comprising an electrolyte additive selected from the group consisting of sodium bis(trifluoromethanesulfonyl)imide) (NaTFSI), tris(trimethylsilyl)phosphate (TSP), lithium nitrate (LiNO3), magnesium nitrate (MgNO3), lithium difluoro (oxalate) borate (LiDFOB), lithium difluorophposphate (LiPF2O2), lithium bis(oxalate) borate (LiBOB), and fluoroethylene carbonate (FEC).
Clause 15. The lithium-metal battery electrolyte of clause 14, wherein the lithium-metal battery electrolyte comprises 0-3% by weight of electrolyte additive.
Clause 16. A lithium-metal battery electrolyte comprising: a diluent having a formula CF2H—(CF2)n—O—CH2—(CF2)m—CF2H where n and m are each separately 0-3; a core mixture comprising a set of salts and a set of solvents; and an electrolyte additive comprising tris(trimethylsilyl)phosphate, wherein: the set of salts comprises a salt having an anion represented by R—SO2—N—SO2—R′, each of R and R′ is selected from the group consisting of F, CF3, C2F5, and C3F7, and the set of solvents comprises an ionic liquid and a molecular solvent.
Clause 17. The lithium-metal battery electrolyte of clause 16, wherein a mole fraction (X1) of the core mixture in the lithium-metal battery electrolyte is 0.4-0.99.
Clause 18. The lithium-metal battery electrolyte of clause 16, wherein a mole fraction (X2) of the set of salts in the core mixture is 0.25-0.55.
Clause 19. The lithium-metal battery electrolyte of clause 16, wherein a mole fraction (X3) of the salt in the set of salts is 0.5 or greater.
Clause 20. The lithium-metal battery electrolyte of clause 16, wherein a mole fraction (X4) of the ionic liquid in the set of solvents is 0.01-0.65.
Clause 21. The lithium-metal battery electrolyte of clause 16, wherein the diluent is 1,1,2,2-tetrafluoroethyl-2,2,3,3-tetrafluoropropyl ether (TFPE).
Clause 22. The lithium-metal battery electrolyte of clause 16, wherein each of R and R′ in R—SO2—N—SO2—R′ representing the salt, is either F or CF3.
Clause 23. The lithium-metal battery electrolyte of clause 16, wherein the set of salts comprises an additional salt, having a different composition from the salt and selected from the group consisting of lithium bis(fluorosulfonyl)imide (LiFSI), lithium bis(trifluoromethylsulfonyl)imide (LiTFSI), lithium tetrafluoroborate (LiBF4), lithium hexafluorophosphate (LiPF6), lithium bis(oxalato) borate (LiBOB), lithium difluoro (oxalato) borate (LiDFOB), lithium trifluoromethanesulfonate (LiTf), lithium nitrate (LiNO3).
Clause 24. The lithium-metal battery electrolyte of clause 23, wherein: the salt is lithium bis(fluorosulfonyl)imide (LiFSI), and the additional salt is lithium bis(trifluoromethylsulfonyl)amide (LiTFSI).
Clause 25. The lithium-metal battery electrolyte of clause 16, wherein the ionic liquid is selected from the group consisting of N-propyl-N-methylpyrrolidinium bis(fluorosulfonyl)imide (Pyr13FSI), N-butyl-N-methylpyrrolidinium bis(fluorosulfonyl)imide (Pyr14FSI), N-pentyl-N-methylpyrrolidinium bis(fluorosulfonyl)imide (Pyr15FSI), N-hexyl-N-methylpyrrolidinium bis(fluorosulfonyl)imide (Pyr16FSI), N-heptyl-N-methylpyrrolidinium bis(fluorosulfonyl)imide (Pyr17FSI), N-octyl-N-methylpyrrolidinium bis(fluorosulfonyl)imide (Pyr18FSI).
Clause 26. The lithium-metal battery electrolyte of clause 16, wherein the ionic liquid comprises N-propyl-N-methylpyrrolidinium bis(fluorosulfonyl)imide (Pyr13FSI) and at least one ionic liquid selected from the group consisting of N-butyl-N-methylpyrrolidinium bis(fluorosulfonyl)imide (Pyr14FSI), N-pentyl-N-methylpyrrolidinium bis(fluorosulfonyl)imide (Pyr15FSI), N-hexyl-N-methylpyrrolidinium bis(fluorosulfonyl)imide (Pyr16FSI), N-heptyl-N-methylpyrrolidinium bis(fluorosulfonyl)imide (Pyr17FSI), N-octyl-N-methylpyrrolidinium bis(fluorosulfonyl)imide (Pyr18FSI), wherein a mole fraction of N-propyl-N-methylpyrrolidinium bis(fluorosulfonyl)imide (Pyr13FSI) in the ionic liquid is greater than 0.75.
Clause 27. The lithium-metal battery electrolyte of clause 16, wherein the molecular solvent is selected from the group consisting of 1,2-dimethoxyethane (DME), 1,2-diethoxyethane (DEE), dimethoxymethane (DMM), 1,3-dimethoxypropane (DMP), dipropylether (DPE), dibutylether (DBE), bis(2-methoxyethyl) ether (G2, diglyme).
Clause 28. The lithium-metal battery electrolyte of clause 16, wherein the molecular solvent comprises 1,2-dimethoxyethane (DME) and another ether selected from the group consisting of, 1,2-diethoxyethane (DEE), dimethoxymethane (DMM), 1,3-dimethoxypropane (DMP), dipropylether (DPE), dibutylether (DBE), bis(2-methoxyethyl) ether (diglyme), wherein a mole fraction of 1,2-dimethoxyethane (DME) in the molecular solvent is greater than 0.75.
Clause 29. The lithium-metal battery electrolyte of clause 16, wherein: a mole fraction (X1) of the core mixture in the lithium-metal battery electrolyte is 0.4-0.99, a mole fraction (X2) of the set of salts in the core mixture is 0.25-0.55, a mole fraction (X3) of the salt in the set of salts is 0.5 or greater, and a mole fraction (X4) of the ionic liquid in the set of solvents is 0.4-0.65.
Clause 30. The lithium-metal battery electrolyte of clause 16, wherein: a mole fraction (X1) of the core mixture in the lithium-metal battery electrolyte is less than 0.65, a mole fraction (X2) of the set of salts in the core mixture is 0.25-0.55, a mole fraction (X3) of the salt in the set of salts is 0.5 or greater, and a mole fraction (X4) of the ionic liquid in the set of solvents is less than 0.3.
Clause 31. The lithium-metal battery electrolyte of clause 16, wherein the electrolyte additive further comprises an additive selected from the group consisting of sodium bis(trifluoromethanesulfonyl)imide) (NaTFSI), lithium nitrate (LiNO3), magnesium nitrate (MgNO3), lithium difluoro (oxalato) borate (LiDFOB), lithium difluorophposphate (LiPF2O2), lithium bis(oxalato) borate (LiBOB), and fluoroethylene carbonate (FEC).
Clause 32. The lithium-metal battery electrolyte of clause 31, wherein the lithium-metal battery electrolyte comprises 0-3% by weight of electrolyte additive.
Clause 33. A lithium-metal rechargeable electrochemical cell comprising: a lithium-metal negative electrode comprising a lithium-metal negative active material layer; a positive electrode comprising a positive active material layer; a separator positioned between the lithium-metal negative electrode and the positive electrode; and a lithium-metal battery electrolyte comprising a diluent and a core mixture comprising a set of salts and a set of solvents, wherein: the set of salts comprises a salt represented by R—SO2—N—SO2-R′, each of R and R′ is selected from the group consisting of F, CF3, C2F5, and C3F7, and the set of solvents comprises an ionic liquid and a molecular solvent.
Clause 34. The lithium-metal rechargeable electrochemical cell of clause 33, wherein the lithium-metal negative active material layer is a standalone structure having a thickness of at least 10 micrometers and operable, at least in part, as a current collector of the lithium-metal negative electrode.
Clause 35. The lithium-metal rechargeable electrochemical cell of clause 34, wherein: a mole fraction (X1) of the core mixture in the lithium-metal battery electrolyte is 0.4-0.99, a mole fraction (X2) of the set of salts in the core mixture is 0.25-0.55, a mole fraction (X3) of the salt in the set of salts is 0.5 or greater, and a mole fraction (X4) of the ionic liquid in the set of solvents is 0.4-0.65.
Clause 36. The lithium-metal rechargeable electrochemical cell of clause 33, wherein: the lithium-metal negative electrode further comprises a negative-electrode base layer formed from a polymer and a negative current collector layer attached to and supported by the negative-electrode base layer, and the lithium-metal negative active material layer is attached to and supported by the negative current collector layer and the negative-electrode base layer such that the negative current collector layer is positioned between the negative-electrode base layer and the lithium-metal negative active material layer.
Clause 37. The lithium-metal rechargeable electrochemical cell of clause 36, wherein: a mole fraction (X1) of the core mixture in the lithium-metal battery electrolyte is less than 0.65, a mole fraction (X2) of the set of salts in the core mixture is 0.25-0.55, a mole fraction (X3) of the salt in the set of salts is 0.5 or greater, and a mole fraction (X4) of the ionic liquid in the set of solvents is less than 0.3.

These and other embodiments are described further below with reference to the figures.

### BRIEF DESCRIPTION OF THE DRAWINGS

FIG. 1 is a block diagram illustrating various components of a lithium-metal rechargeable electrochemical cell, in accordance with some examples.

FIG. 2 is a block diagram illustrating various components of a liquid electrolyte of a lithium-metal rechargeable electrochemical cell, in accordance with some examples.

FIG. 3A is a plot of Li-ion activity modeled for a lithium-metal electrochemical cell at varying mole fraction of core mixture in lithium-metal battery electrolyte, in accordance with some examples.

FIG. 3B is a plot of viscosity measured for lithium-metal battery electrolytes for varying mole fractions of core mixture in lithium-metal battery electrolyte, in accordance with some examples.

FIG. 3C is a plot of electrolyte ionic conductivity measured at varying mole fraction of salt in core mixture for three different electrolyte solutions, in accordance with some examples.

FIG. 3D is a plot of coulombic efficiency (CE) measured for Li|Cu coin cells with electrolytes of varying mole fraction of set of salts in core mixture, in accordance with some examples.

FIG. 3E is a plot of leakage current, expressed in C-Rate, plotted against varying mole fraction of salt in set of salts, in accordance with some examples.

FIG. 3F is plot of CE measured for Li|Cu coin cells with electrolytes of varying mole fraction of salt in set of salts, in accordance with some examples.

FIG. 3G is a plot of lithium plating/stripping efficiency measured for Li|Cu coin cells with electrolytes varying in mole fraction of ionic liquid (IL) in set of solvents, in accordance with some examples.

FIG. 3H is a plot of Li-ion transference number measured via pulsed-field gradient nuclear magnetic resonance (PFG NMR) for electrolytes of varying mole fraction of ionic liquid in set of solvents, in accordance with some examples.

FIG. 3I is a plot of oxidative leakage current measured after a 50 hour hold at 4.4 V using an NMC811 working electrode for cells with electrolytes of varying mole fraction of ionic liquid in set of solvents, in accordance with some examples.

FIG. 3J is a plot of oxidative leakage current for a cell with a baseline electrolyte composition and cells each varying in mole fraction of one component, in accordance with some examples.

FIG. 4 is a process flowchart corresponding to a method of fabricating a lithium-metal rechargeable electrochemical cell, in accordance with some examples.

FIG. 5 is a block diagram of an electric vehicle using lithium-metal rechargeable electrochemical cells, in accordance with some examples.

### DETAILED DESCRIPTION

### Introduction

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

As noted above, Li-metal cells operate with lithium metal plating on the negative electrodes without being contained by or trapped inside other materials (e.g., graphite, which is commonly used in Li-ion cells). In lithium-ion cells, lithium is intercalated or alloyed into negative electrode active materials, such as graphite or silicon. In lithium-metal cells, lithium metal is plated on the surface of the current collector as a free-standing metal layer. Because of this unique design, Li-metal cells tend to have a lower weight and higher energy density in comparison to Li-ion cells. Both of these qualities are highly beneficial for many applications, such as aircraft, spacecraft, and the like. At the same time, this unique design can also cause unique failure modes. For example, with charge/discharge cycles, lithium metal is plated on the surface of the current collector as a free-standing metal layer. Over many cycles, the repeated plating and stripping of lithium metal can build up porous lithium metal structures on the negative electrode. This is more likely at higher charging rates. These porous structures can have a significantly higher surface area in comparison to a starting lithium structure, such as lithium foil. With repeated charging/discharging cycles, the porous lithium metal structures can grow sufficiently to form electrical shorts resulting in battery failure. In addition, the electrolyte can be forced into these pores, resulting in electrolyte consumption and the formation of a thick solid electrolyte interphase (SEI) layer. SEI formation is necessary to passivate the lithium metal surface, but if the SEI formation is uncontrolled, it causes electrolyte depletion and increases the cell impedance (also adding to a larger overpotential and limiting the capacity available upon the discharge). As such, uniform lithium plating on the current collector can help to mitigate this failure mode. As will be described below, the disclosed electrolyte provides excellent lithium metal deposition quality throughout a large number of charge/discharge cycles, including at high charge rates.

Oxidative stability is an important property of an electrolyte solution for a lithium-metal battery. Some electrolytes can undergo degradation at high voltage cathodes, including at lithium-metal electrodes. Degradation means electrochemical decomposition products forming from the components of the electrolyte reacting at the voltages at the cathode. Degradation can alter the composition of the electrolyte solution over time in two ways. First, degradation can decrease the concentration of the degraded component of the electrolyte solution, leading to changes in the electrochemical properties of the electrolyte solution. Second, degradation products can have undesirable effects on electrochemical reactions at anode or cathode, leading to degradation of the lithium-metal battery performance. Electrode damages on the negative electrode can come in the form of side reactions that consume the lithium metal active material and build up impedance-contributing decomposition products. Electrode damage on the positive electrode can come in the form of impedance build-up from decomposition products and phase changes of the active material limiting the reversibility of cycling. For the purposes of this disclosure, Coulombic efficiency means the percentage of electrons passed in an electrochemical cell that produce the desired electrochemical reaction, instead of unwanted side reactions (e.g. the ratio between the charge and discharge capacity for a given cycle). In this disclosure, the intended reactions are plating and stripping of lithium metal at the negative electrode, as well as delithiation and lithiation of the cathode active material at the positive electrode, during charge and discharge, respectively.

Lithium-metal battery cells generate heat during discharge. During rapid discharge, cell temperature can increase significantly from ambient temperature. For rapid discharging, it is important that the electrolyte solution is thermally stable at increased temperatures. Thermally instable electrolyte solutions may have components that separate from the solution or precipitate from the solution, changing the composition, and therefore the electrochemical properties, of the electrolyte. For example, solvents with high volatility may not be stably dissolved enough in the electrolyte solution to allow operation of the battery cell at temperatures above ambient up to and including 45° C.

It should be noted that for purposes of this disclosure, a positive electrode can be referred to as a cathode, regardless of the charging or discharging state of the cell. Similarly, a negative electrode can be referred to as an anode, regardless of the charging or discharging state of the cell. In other words, “cathode” and “anode” are simply used to differentiate two electrodes regardless of the relative potentials of these electrodes.

Additionally, a battery module may include a set of pouch battery cells that are stacked in at least one direction and are electrically interconnected (e.g., in series, parallel, and/or various combinations of in series and parallel connections). Because of the volumetric and mass requirements for many applications, individual cells within battery modules are packed as tightly together as possible, leaving minimal space, if any, between a pair of adjacent cells. This tight packing creates additional challenges with controlling the fire propagation in thermal runaway events. For example, lithium metal, ejected from one cell, can quickly reach adjacent cells causing various damage, such as reactive with the external components of these adjacent cells, heating these cells, and causing external shorts of these cells (e.g., upon reaching the external terminals). Because these unsafe conditions are often associated with excessive temperatures that the cells experience while being damaged, the propagation of unsafe conditions can be also referred to as a thermal runaway. As such, a thermal runaway and propagation of unsafe conditions are used interchangeably in this disclosure. In general, a thermal runaway is defined as a state in which a defect or failure causes a battery's rate of heat generated to exceed the rate of heat dissipated. High temperatures (e.g., above 180° C. for Li-metal cells) can cause further exothermic reactions, leading to additional heating. In extreme examples, cells can catch fire and even explode. In these instances, the internal components of the cell, including electrolyte, positive active materials, and metal lithium can be ejected from the cell casing and impinge on other cells within the battery assembly, causing these other cells to enter their thermal runaway. It should be noted that regardless of the naming convention, the concern is with the discharge of lithium metal from one or more lithium-metal cells in a battery assembly and preventing this lithium metal from causing additional damage within the battery assembly and/or outside of the battery assembly.

Disclosed here are lithium-metal rechargeable electrochemical cells comprising pyrrolidinium-containing ionic liquids (ILs) in their electrolytes. Pyrrolidinium-containing ionic liquids can provide several desirable benefits when included in the electrolyte of lithium-metal rechargeable electrochemical cells. These ionic liquids are fire resistant, which can help reduce the chances of thermal runaway occurring if one electrochemical cell of a battery module is damaged. These ionic liquids are also oxidatively stable, meaning they are resistant to decomposition when exposed to high voltages at the lithium-metal electrode. These ionic liquids are thermally stable and form electrolyte solutions that are thermally stable at temperatures reached by lithium-metal rechargeable cells undergoing rapid discharge. In addition, they can suppress positive active material degradation and SEI formation described above.

Pyrrolidinium-containing ionic liquids may further comprise diluents, secondary solvents, electrolyte additives and salts. Of these, the performance of a battery comprising a pyrrolidinium-containing ionic liquid electrolyte may be most sensitive to the concentration of salts in the electrolyte mixture. Too high a concentration of salt may lead to salt deposition from the electrolyte or failure of the electrolyte to form a stable, homogeneous solution, which may result in conductivity and viscosity of the electrolyte that limit the discharge rate of the battery. Too low a concentration may result in a drop in lithium plating/stripping efficiency. As will be described in more detail below, the concentrations of ionic liquids, diluents, secondary solvents, and electrolyte additives in the electrolyte also affect the performance of the battery.

### Lithium-Metal Rechargeable Electrochemical Cell Examples

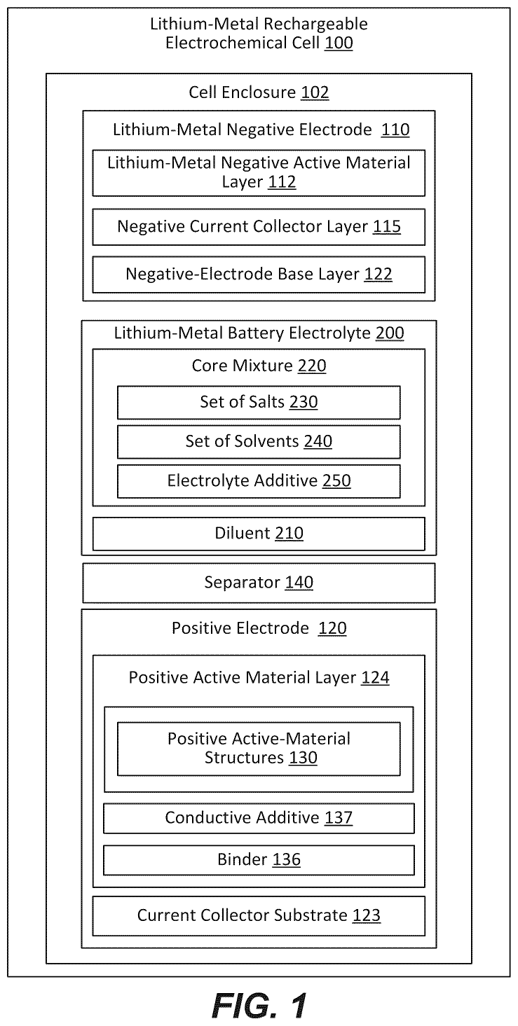

FIG. 1 is a block diagram illustrating various components of lithium-metal rechargeable electrochemical cell 100, in accordance with some examples. Lithium-metal rechargeable electrochemical cell 100 comprises lithium-metal negative electrode 110, positive electrode 120 and lithium-metal battery electrolyte 200 providing the ionic conductivity between lithium-metal negative electrode 110 and positive electrode 120. In some examples, the positive electrode 120 comprises positive active-material structures 130, such as single-crystal nickel-manganese-cobalt (NMC)-containing structures. Lithium-metal rechargeable electrochemical cell 100 can also include other components, such as separator 140 and cell enclosure 102. Separator 140 is positioned between lithium-metal negative electrode 110 and positive electrode 120 and provides electronic isolation between lithium-metal negative electrode 110 and positive electrode 120. One having ordinary skill in the art would understand that lithium-metal rechargeable electrochemical cell 100 can have any number of positive and negative electrodes arranged in different ways, e.g., stacked, wound, and the like. Each of these components will now be described in more detail.

### Examples of Lithium-Metal Negative Electrode

Lithium-metal negative electrode 110 comprises a lithium-metal negative active material layer 112, as a standalone structure or supported using another non-lithium layer (e.g., another metal layer, a polymer layer, and the like). Some examples of non-lithium layers include, but are not limited to, copper, aluminum, titanium, nickel, stainless steel, a metalized polymer substrate (e.g., metalized with copper), and a carbon-coated metal substrate. When these non-lithium layers are electronically conductive, these layers may be referred to as current collectors (used to transfer the current caused by lithium plating/stripping to cell terminals). The purpose of using a negative electrode with a lithium-metal layer deposited on a current collector (in lithium-metal electrochemical cells) is to reduce the size of the negative electrode (e.g., in comparison to lithium-ion cells). For example, the thickness of the lithium-metal layer can be less than 20 micrometers. In some examples, the thickness of the lithium-metal layer can be more than 10 micrometers. Furthermore, the addition of a current collector also helps to keep the thickness of the lithium-metal layer small. For example, thicknesses of less than 20 micrometers are difficult to achieve with freestanding lithium foil. As such, lithium-metal cells with negative electrodes formed by freestanding lithium foils/layers require substantially more lithium than lithium-metal cells with negative electrodes formed by a combination of a current collector and a lithium-metal layer (to achieve the same cell capacity). Aluminum has a better conductivity-to-weight ratio than copper, which can help to increase the gravimetric energy density. Furthermore, aluminum's tensile strength can be up to 600 MPa, while titanium's tensile strength can exceed 1,000 MPa (in some alloys). As such, both aluminum and titanium provide a strong mechanical base even when used as thin foils. In some examples the lithium-metal negative electrode 110 comprises a non-lithium layer, which may be referred to as a negative-electrode base layer 122. For example, the negative-electrode base layer 122 may have a thickness of between 2 micrometers and 20 micrometers or, more specifically, 4 micrometers and 10 micrometers. In the same or other examples, negative-electrode base layer 122 is a metal foil. However, other structures (e.g., mesh, foam) are within the scope. In some examples, the lithium-metal negative electrode 110 comprises a negative-electrode base layer 122 formed from a polymer and a negative current collector layer 115 attached to and supported by the negative-electrode base layer. In these examples, the lithium-metal negative active material layer 112 is attached to and supported by the negative current collector layer 115 and the negative-electrode base layer 122 such that the negative current collector layer 115 is positioned between the negative-electrode base layer 122 and the lithium-metal negative active material layer 112. Lower amounts of lithium are highly desirable from a safety perspective as less lithium ejecta (e.g., molten lithium ejecta) needs to be contained when the cell goes into a thermal runaway. Alternatively, lithium-metal negative electrode 110 is formed entirely from a lithium-metal layer, which is sufficiently thick. In this example, a portion of this layer can be used as a current collector, while another portion is used as a source of lithium ions during the cell discharge.

It should be noted that lithium-metal negative electrode 110 forms a solid electrolyte interphase (SEI) layer when exposed to lithium-metal battery electrolyte 200 at operating potentials. Furthermore, a naturally-forming SEI layer can be supplemented with or partially/fully replaced with an artificial SEI layer (e.g., formed on the surface of lithium-metal negative electrode 110 before contacting lithium-metal battery electrolyte 200). In either case, an SEI layer (natural and/or artificial) can interfere with the lithium-ion migration in and out of lithium-metal negative electrode 110. Raising the temperature before charging, helps to improve the ionic conductivity of such SEI layers.

### Examples of Positive Electrodes

In some examples, positive electrode 120 may comprise current collector substrate 123 with one or multiple positive active material layers 124 adhered to and supported by current collector substrate 123 (e.g., an aluminum foil). Alternatively, current collector substrate 123 comprises one or more metal layers supported on positive polymer layer (e.g., an aluminum-metalized polymer). Each positive active material layer 124 comprises positive active-material structures 130, e.g., single-crystal NMC-containing structures and, in some examples, other components, such as conductive additives 137 (e.g., carbon black/paracrystalline carbon, carbon nanotubes) and binder 136 (e.g., polyvinylidene fluoride (PVDF), styrene-butadiene rubber (SBR), and carboxyl methyl cellulose (CMC)). For purposes of this disclosure, “single-crystal NMC-containing structures” are defined as individual structures that are not directly agglomerated with each other such that each single-crystal structure is formed by an individual grain of layered metal oxides e.g., nickel oxide, manganese oxide, and cobalt oxide. Single-crystal NMC-containing structures should be distinguished from polycrystalline structures, which are more common for NMC-containing materials, and which are defined as agglomerates of multiple different crystalline structures as described above.

In some examples, nickel has a concentration of at least 70% atomic in NMC-containing positive active-material structures 130 (e.g., single-crystal NMC-containing structures) or even at least 80% atomic and even at least 85% atomic. The higher nickel concentration corresponds to a higher lithium storage capacity.

In some examples, positive electrode 120 comprises single-crystal nickel-manganese-cobalt (NMC)-containing structures, used as positive active material structures 130. The single-crystal NMC-containing structures can have a nickel concentration of at least 70% atomic or even at least 80% atomic. Because the bonds within the primary particles are stronger than between primary particles (in polycrystalline materials), single-crystal NMC particles inherently do not have or show intergranular cracking in a way that polycrystalline NMC particles do. Furthermore, single-crystal NMC particles tend to have higher specific capacities due to the greater surface-area-to-volume ratio of the individual particles vs. secondary-particle agglomerates of polycrystalline NMC materials. However, single-crystal NMC particles tend to have slower lithium transport kinetics than polycrystalline materials. As such, increased temperatures during the charge portion of the cycle help with increasing the rate of lithium-ion extraction from single-crystal NMC particles.

### Examples of Separators

Referring again to FIG. 1, the lithium-metal rechargeable electrochemical cell 100 may comprise a separator 140 that provides physical and electronic isolation between lithium-metal negative electrode 110 and positive electrode 120. Additionally, separator 140 may function as an ionically conductive membrane that conveys lithium ions (in lithium-metal battery electrolyte 200) between lithium-metal negative electrode 110 and positive electrode 120. Separator 140 can be a thin layer (e.g., 1-50 microns thick) with a porosity of 20-60%. Separator 140 may be composed of carbon-based polymer chains with or without inorganic compounds (e.g., aluminum oxide, titanium oxide) for reinforcement. Overall, separator 140 can be formed from one or more polyolefins (e.g., polyethylene, polypropylene) and/or non-polyolefin materials (e.g., cellulose, polyimide, polyethylene terephthalate (PET), and glass). In some variations, separator 140 may include a coating of or be layered with other material, e.g., ceramics, surfactant, and/or polymer with or without inorganic fillers.

### Examples of Cell Enclosures

Positive electrode 120, lithium-metal negative electrode 110, separator 140, and lithium-metal battery electrolyte 200 can be referred to as internal components of lithium-metal rechargeable electrochemical cell 100. These internal components are sensitive to moisture and other ambient conditions and insulated from the environment by a cell enclosure, such as a metal (e.g., aluminum) case (e.g., for cylindrical or prismatic cells), a pouch laminate, an aluminum-coated polymer (e.g., polyamide, polyester, polyurethane, and polypropylene). It should be noted that Lithium-metal rechargeable electrochemical cell 100 can be heated internally and/or externally. When internal heating is used, the cell enclosure can be thermally insulated to reduce heat dissipation to the environment. Some examples of such thermally insulating features include, but are not limited to, different intercell structures (e.g., thermal-barrier sheet). It should be noted that such structures can also be used for applying cell pressure and/or preventing heat/material propagation during various thermal events. On the other hand, when external heating is used, the cell enclosure can be thermally conductive to promote heat transfer from an externally positioned heater to the cell interior. Some examples of such thermally conductive features include, but are not limited to, intercell heat-conducting structures (e.g., also used for cell cooling during other operations).

### Examples of Lithium-Metal Battery Electrolytes

Lithium-metal battery electrolyte 200 provides ionic transfer between lithium-metal negative electrode 110 and positive electrode 120. For example, Lithium-metal battery electrolyte 200 soaks separator 140 or, more specifically, the pores of separator 140. Lithium-metal battery electrolyte 200 should be distinguished from solid and gel electrolytes used in other types of lithium-metal cells. Lithium-metal battery electrolyte 200 should be distinguished from gel electrolytes, in which polymer matrices are used to retain salts and solvents. Lithium-metal battery electrolyte 200 described herein are free from polymer components such as polyacrylonitrile (PAN), polymethylmethacrylate (PMMA), polyvinylchloride (PVC), and polyvinylidene fluoride (PVDF). Additionally, Lithium-metal battery electrolyte 200 described herein is free from polymeric ionic liquids wherein one ion of the ionic liquid is part of a polymer chain. Lithium-metal battery electrolyte 200 described herein have a viscosity of less than 1,000 cP, less than 500 cP, less than 200 cP, less than 100 cP, or even less than 75 cP at the room temperature.

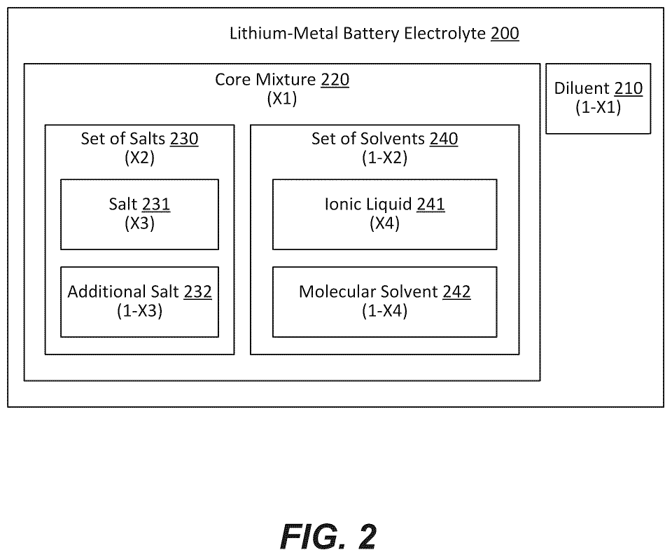

FIG. 2 is a block diagram illustrating various components of lithium-metal battery electrolyte 200, in accordance with some examples. Lithium-metal battery electrolyte 200 comprises a diluent 210 and a core mixture 220. The core mixture 220 comprises a set of salts 230 and a set of solvents 240. The set of salts 230 comprises a salt 231 represented by by R—SO₂—N—SO₂—R′, wherein each of R and R′ is selected from the group consisting of F, CF₃, C₂F₅, and C₃F₇. The set of solvents 240 comprises an ionic liquid 241 and a molecular solvent 242.

The mole fractions of different components of the lithium-metal battery electrolyte 200 are identified in FIG. 2 with X1, X2, X3, and X4. For example, the lithium-metal battery electrolyte 200 comprises a diluent 210 and a core mixture 220. In some examples, the mole fraction ratio of the core mixture 220 in the lithium-metal battery electrolyte 200 is identified with X1 and can be between 0.4-0.99 or, more specifically, between 0.7-0.9 or even between 0.75-0.85. In other examples, this molar fraction (X1) can be between 0.45-0.8, between 0.45-0.65, or even between 0.5-0.6. The diluent 210 has a mole fraction in the lithium-metal battery electrolyte 200 of 1-X1. The diluent 210 has a formula CF₂H—(CF₂)ₙ—O—CH₂—(CF₂)ₘ—CF₂H where n and m are each separately 0-3. The diluent 210 should be electrochemically inert to the high voltage cathode. The diluent 210 may include various examples of solvents such as 1,1,2,2-tetrafluoroethyl-2,2,3,3-tetrafluoropropyl ether (TFPE), 2,2,2-trifluoroethyl-1,1,2,2-tetrafluoroethyl ether (TFEE), bis(2,2,3,3-tetrafluoropropyl) ether, or 1,2-(1,1,2,2-tetrafluoroethoxy) ethane. 1,1,2,2-tetrafluoroethyl-2,2,3,3-tetrafluoropropyl ether (TFPE) allows for enhanced oxidative stability and lowered viscosity without sacrificing lithium plating and stripping efficiencies.

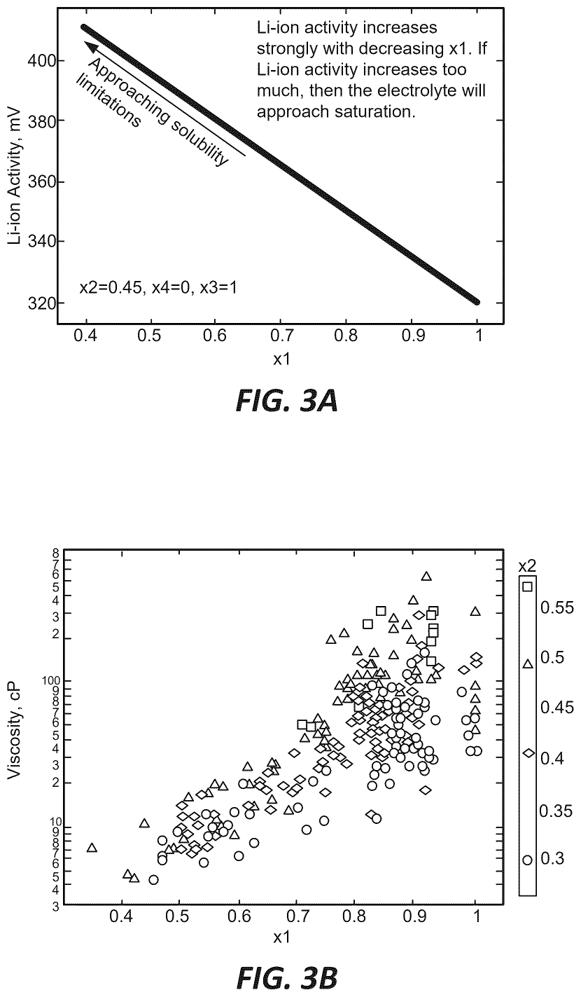

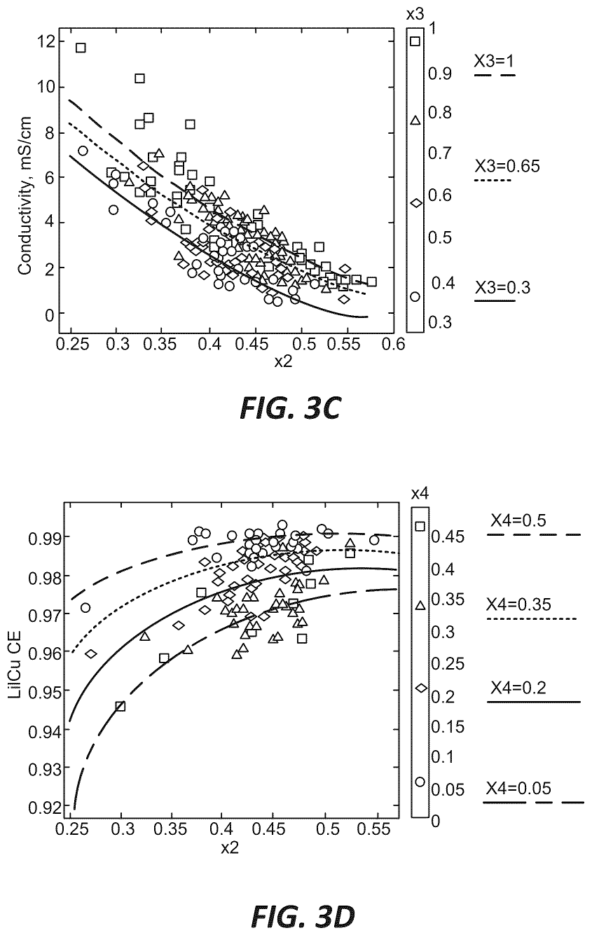

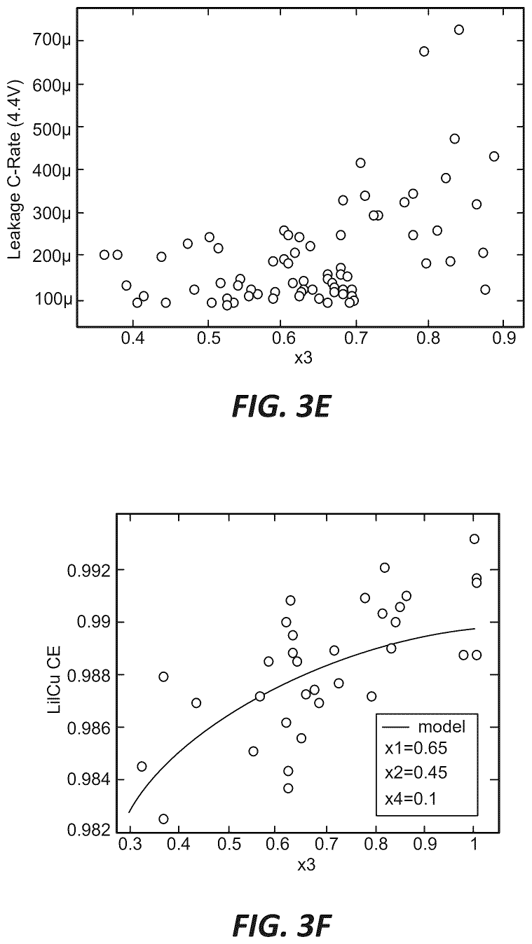

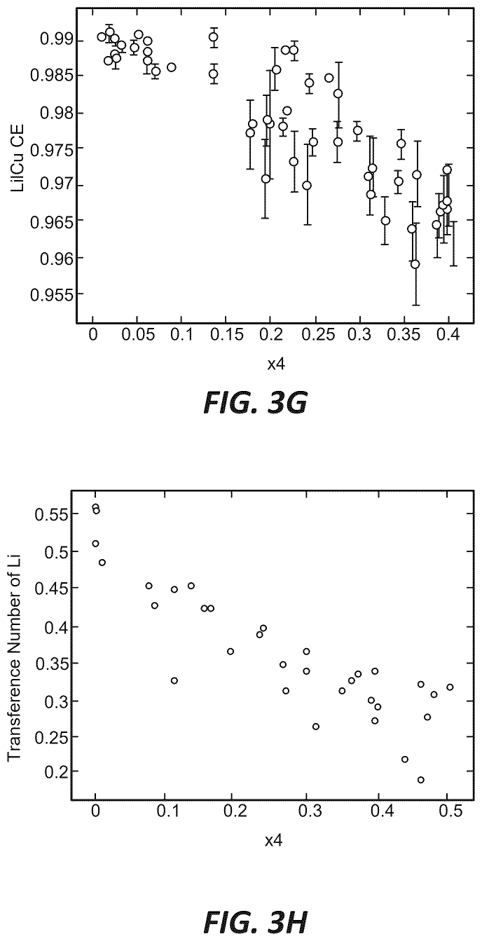

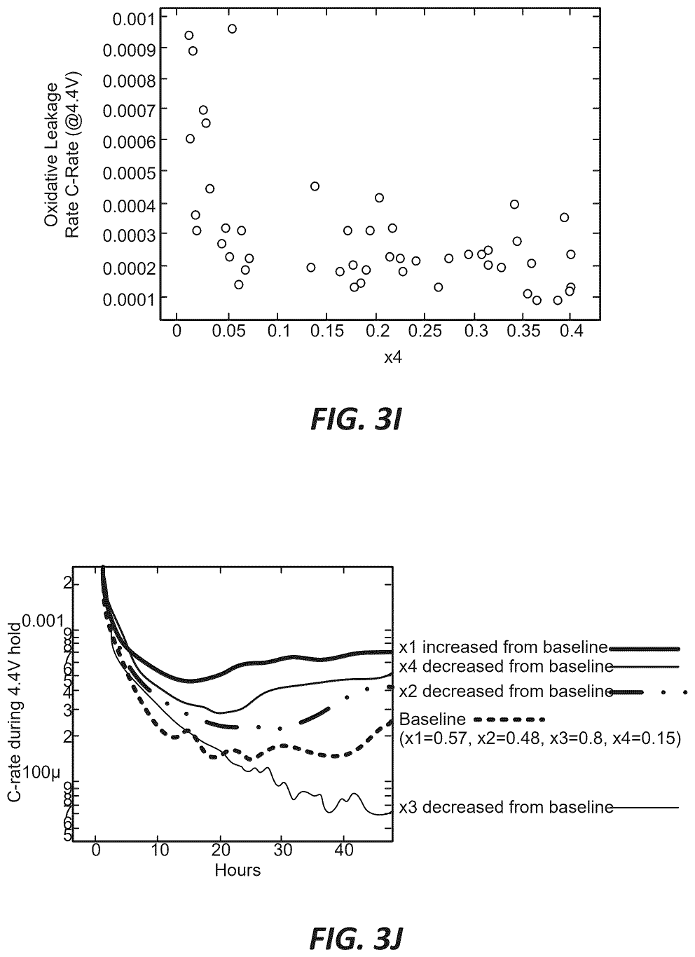

It should be noted that the set of solvents 240, which comprises an ionic liquid 241 and a molecular solvent 242, are excluded from the category of diluents. The diluent 210 may be used to control (e.g., reduce) the viscosity of lithium-metal battery electrolyte 200 without interfering with other preferable electrolyte properties. The diluent 210 may lubricate the lithium-metal battery electrolyte 200 which may otherwise suffer from high viscosity and low lithium ion diffusivity. High viscosity and low lithium ion diffusivity may result in poor wetting of the cell components by the lithium-metal battery electrolyte 200, as well as large concentration overpotential. A large concentration overpotential may result in severe electrochemical rate limitations during charging and discharging. Shown in FIG. 3B are viscosities measured for electrolytes as a function of X1, with the electrolytes having different values of X2, in accordance with some examples. The values of X3 varied from 0.3 to 1 and X4 varied from 0 to 0.6 in these examples. These results demonstrate a correlation between X1 and viscosity. As X1 increases towards 1, e.g. decreasing molar fraction of diluent 210 in the lithium-metal battery electrolyte 200, viscosity of the lithium-metal battery electrolyte 200 increases. Furthermore, it is desirable for the diluent 210 to conserve the lithium ion coordination environment of the lithium-metal battery electrolyte 200, so as to maintain the compatibility of the lithium-metal battery electrolyte 200 with the lithium-metal negative electrode 110 and SEI chemistry. The amount of diluent 210 that can be added to the electrolyte depends on the saturation level of the core mixture 220. As diluent 210 is introduced to lithium-metal battery electrolyte 200, the dielectric constant of the lithium-metal battery electrolyte 200 decreases, the lithium ion activity increases, and salt may begin to precipitate out of solution. Thus, the lower bound of X1, e.g. upper bound of mole fraction of diluent in the lithium-metal battery electrolyte 200, is primarily to ensure solubility of the set of salts 230 in the lithium-metal battery electrolyte 200. Furthermore, if the lithium-metal battery electrolyte 200 is too close to the saturation point, then saturation limits may be observed during high-rate discharges near the anode, where there is an accumulation of the set of salts 230 within the lithium-metal battery electrolyte 200. Plotted in FIG. 3A is the Li-ion activity (as modeled by the change in Li|Li+ redox potentials with respect to a standard 1M lithium bis(trifluoromethanesulfonyl)imide (LiFSI) in dimethoxyethane (DME) solution) at varying X1 values for an electrolyte with X2=0.45, X3=1, and X4=0, in accordance with some examples. The Li-ion activity increases by about 100 mV as X1 varies from 1 to 0.4, in other words, as the mole fraction of diluent 210 in the lithium-metal battery electrolyte 200 increases. This increase in activity indicates the lithium-metal battery electrolyte 200 is getting close to its saturation point. When electrolytes exceed 450 mV of Li-ion activity, it is typically an indication that the electrolyte is saturated.

The core mixture 220 comprises a set of salts 230 and a set of solvents 240. In some examples, the lithium-metal battery electrolyte 200 has a mole fraction (X2) of the set of salts 230 in the core mixture 220 between 0.25-0.55, or more specifically, between 0.35-0.55, or even between 0.43-0.5. In some examples, the set of salts 230 comprises lithium-containing salts. The set of salts 230 are configured to dissociate into lithium ions and anions in the lithium-metal battery electrolyte 200. In some examples, the concentration of the set of salts 230 in lithium-metal battery electrolyte 200 is between 10 mol % and 50 mol % or, more specifically, between 20 mol % and 40 mol %. As X2 increases, the lithium-metal battery electrolyte 200 becomes closer to a saturation point beyond which it may not form a stable, homogeneous solution. Increasing X2 above 0.55 risks solubility limitations. Furthermore, at higher values of X2, the conductivity, viscosity, and thus the discharge rate capability of the lithium-metal battery electrolyte 200 may be severely limited. For example, shown in FIG. 3C is electrolyte ionic conductivity measured at varying values of X2 for three different electrolyte solutions. These electrolyte solutions, in which X3 was 1, 0.65, and 0.3, respectively, had X1 varying between 0.4-1 and X4 varying between 0-0.5. The conductivity decreases as X2 increases for all three electrolytes.

As the value of X2 decreases, a drop-off is observed in lithium plating/stripping coulombic efficiency (CE). For example, shown in FIG. 3D is a plot of lithium plating/stripping efficiency measured for Li|Cu coin cells with electrolytes varying in X2, in accordance with some examples. Coulombic efficiency was tested using the Aurbach method. Results are provided for electrolytes with four different values of X4. These results show that as X2 decreases, the CE decreases. Specifically, when X4=0.05, enhanced ionic conductivity due to high salt concentration leads to high CE when X2 is above 0.35. However, at lower values of X2, this benefit is negated by the incompatibility of the electrolyte with lithium metal and CE decreases.

In some examples, the set of salts 230 comprises a salt 231 having an anion represented by R—SO₂—N—SO₂—R′, where each of R and R′ is either F or CF₃. In some examples, set of salts 230 comprises a salt 231 having an anion bis(fluorosulfonyl)imide and an additional salt 232 having a different composition from the salt 231. In some examples, the additional salt 232 is selected from salts having an anion represented by R—SO₂—N—SO₂—R′, where each of R, and R′ is selected from the group consisting of CF₃, C₂F₅, and C₃F₇. In some examples, each of R and R′, in R—SO₂—N—SO₂—R′ representing the anion of the additional salt 232 is a trifluoromethyl group (CF₃) and the additional salt 232 is LiTFSI. In some examples, the additional salt 232 is selected from the group consisting of lithium tetrafluoroborate (LiBF4), lithium hexafluorophosphate (LiPF6), lithium bis(oxalato) borate (LiBOB), lithium difluoro (oxalato) borate (LiDFOB), lithium trifluoromethanesulfonate (LiTf), lithium nitrate (LiNO3). In some examples, X3, which represents the mole fraction of the salt 231 in the set of salts 230 in the core mixture 220, is 0.5 or greater, for example, 0.65, 0.85, or even 0.95. In some examples, the salt 231 is lithium bis(fluorosulfonyl)imide (LiFSI), and the additional salt 232 is lithium bis(trifluoromethylsulfonyl)amide (LiTFSI).

Increasing the mole fraction of LiFSI in the set of salts 230 may promote faster ion transport, observed as higher conductivity with increasing X3 as shown in FIG. 3C. Shown in FIG. 3F is plot of CE measured for Li|Cu coin cells with electrolytes of varying X3, in accordance with some examples. Increasing the mole fraction LiFSI improves compatibility of the lithium-metal battery electrolyte 200 with the lithium-metal negative electrode 110, observed as an increase in CE. However, including LiTFSI in the set of salts 230 enhances oxidative stability. Shown in FIG. 3E is a plot of leakage current, expressed in C-Rate, plotted against varying X3, in accordance with some examples. The steady-state current was measured after 50 hours held at 4.4 V. The results show that leakage current increases, indicating decreasing oxidative stability of the electrolyte, as the value of X3 increases.

The set of solvents 240 comprises an ionic liquid 241 and a molecular solvent 242. In some examples, the ionic liquid 241 is selected from the group consisting of N-propyl-N-methylpyrrolidinium bis(fluorosulfonyl)imide (Pyr13FSI), N-butyl-N-methylpyrrolidinium bis(fluorosulfonyl)imide (Pyr14FSI), N-pentyl-N-methylpyrrolidinium bis(fluorosulfonyl)imide (Pyr15FSI), N-hexyl-N-methylpyrrolidinium bis(fluorosulfonyl)imide (Pyr16FSI), N-heptyl-N-methylpyrrolidinium bis(fluorosulfonyl)imide (Pyr17FSI), N-octyl-N-methylpyrrolidinium bis(fluorosulfonyl)imide (Pyr18FSI). In some examples, the ionic liquid 241 comprises N-propyl-N-methylpyrrolidinium bis(fluorosulfonyl)imide (Pyr13FSI) and at least one ionic liquid selected from the group consisting of N-butyl-N-methylpyrrolidinium bis(fluorosulfonyl)imide (Pyr14FSI), N-pentyl-N-methylpyrrolidinium bis(fluorosulfonyl)imide (Pyr15FSI), N-hexyl-N-methylpyrrolidinium bis(fluorosulfonyl)imide (Pyr16FSI), N-heptyl-N-methylpyrrolidinium bis(fluorosulfonyl)imide (Pyr17FSI), N-octyl-N-methylpyrrolidinium bis(fluorosulfonyl)imide (Pyr18FSI), wherein the mole fraction of N-propyl-N-methylpyrrolidinium bis(fluorosulfonyl)imide (Pyr13FSI) in the ionic liquid 241 is greater than 0.75. In some examples, the concentration of the ionic liquids in lithium-metal battery electrolyte 200 is between 0 mol % and 40 mol % or, more specifically, between 5 mol % and 35 mol %, or even between 10 mol % and 30 mol %.

In some examples, the mole fraction of the ionic liquid 241 in the set of solvents 240 is represented by X4. In some examples, X4 has a value between 0.01-0.65, or between 0.2-0.5, or between 0.3-0.45, or even between 0.4-0.65. Shown in FIG. 3G is CE measured for Li|Cu coin cells with electrolytes of varying X4, in accordance with some examples. As shown in FIG. 3G, increasing IL content (increasing X4) decreases the Li|Cu CE, indicating a decrease in the compatibility of the lithium-metal battery electrolyte 200 with the lithium-metal negative electrode 110. Shown in FIG. 3H is the Li-ion transference number measured via pulsed-field gradient nuclear magnetic resonance (PFG NMR) for electrolytes varying in X4, in accordance with some examples. Decreasing transference number with increasing X4 indicates a decreasing discharge rate capability of the electrolyte. However, increasing IL content enhances oxidative stability of the lithium-metal battery electrolyte 200. Shown in FIG. 3I is a plot of oxidative leakage current measured after a 50 hour hold at 4.4 V for cells with electrolytes varying in X4, in accordance with some examples. The results in FIG. 3I indicate a sharp increase in leakage current as the value of X4 decreases past 0.05, or in other words, as the mole fraction of the ionic liquid 241 in the set of solvents 240 decreases.

More specifically, as noted above, in some examples the lithium-metal negative electrode 110 may be formed from a lithium foil, which may have a thickness of, for example, 30 micrometers or more. In these examples, the number of charge/discharge cycles of the lithium-metal rechargeable electrochemical cell 100 may not be limited by sufficient lithium inventory of the lithium-metal negative electrode 110 and sufficient plating/stripping efficiency. In these examples, X4 may not be optimized for CE.

In other examples, as noted above, the lithium-metal negative electrode 110 may comprise a thin lithium-metal negative active material layer 112 and a negative-electrode base layer 122. In these examples, the lithium-metal negative active material layer 112 may have a thickness of less than 10 micrometers, less than 5 micrometers, or even less than 3 micrometers. In these examples, the value of X4 may be chosen to optimize CE to maintain lithium inventory at the lithium-metal negative electrode 110 during multiple plating/stripping cycles. In these examples, X4 has a value between 0.01-0.3, or between 0.05-0.15, or even between 0.8-0.13. In further other examples, lithium-metal battery electrolyte 200 with X4 values less than 0.3, less than 0.15, or even less than 0.13 may have lower oxidative stability, as shown in FIG. 3I. In these examples, X1 may be less than 0.8, or even less than 0.65 to improve oxidative stability. As shown in FIG. 3J, the leakage current measured for an electrolyte with X1=0.57, X2=0.48, X3=0.8, and X4=0.15 was lower than measured for an electrolyte with higher X1.

Some examples of molecular solvent 242 include but are not limited to, one or more cyclic ethers (e.g., 1,3-dioxane (DOL), 1,4-dioxane (DX), tetrahydrofuran (THF)), one or more linear ethers (e.g., 1,2-dimethoxyethane (DME), 1,2-diethoxyethane (DEE), dimethoxymethane (DMM), 1,3-dimethoxypropane (DMP), dipropylether (DPE), dibutylether (DBE), bis(2-methoxyethyl) ether (G2, diglyme), triethylene glycol dimethyl ether (G3), or tetraethylene glycol dimethyl ether (G4), and a combination thereof. In some examples, the concentration of molecular solvent 242 in lithium-metal battery electrolyte 200 is between 0 mol % and 60 mol % or, more specifically, between 5 mol % and 50 mol % or even between 10 mol % and 40 mol %.

For purposes of this disclosure, the term “molecular solvent” is defined as any solvent that is not an ionic liquid. As such, a molecular solvent can be also referred to as a non-ionic-liquid solvent. Molecular solvents consist of individual molecules (e.g., with covalent bonds), while ionic liquids are composed of ions. In molecular solvents, there are no charged ions present in the solvent molecules themselves. The ionic liquids' ions have an inherent charge and are often chosen to be bulky and asymmetric, which contributes to the unique properties of ionic liquids.

In some examples, lithium-metal battery electrolyte 200 can have a viscosity of at least 15 cP or, more specifically, at least 25 cP, at least 50 cP, or even at least 100 cP at room temperature. For example, lithium-metal battery electrolyte 200 can have a viscosity of 15-500 cP or, more specifically, 20-300 cP or, more specifically, 40-200 cP at room temperature. High viscosity can be driven by specific components needed in lithium-metal battery electrolyte 200 to enable the functioning of lithium-metal battery electrolyte 200 in lithium-metal rechargeable electrochemical cell 100. It should be noted that the viscosity changes with temperature. In fact, this characteristic is used to enable the controlled deposition of lithium metal during fast charging (e.g., a charge rate of at least 0.8C or even at least 1C). The viscosity determines the ionic diffusivity (lithium ions) within lithium-metal battery electrolyte 200. In some examples, lithium-metal battery electrolyte 200 can have an ionic diffusivity of between 1E-13 m²/sec-1E-10 m²/see or, more specifically, 5E-12 m²/sec-5E-10 m²/see or, even more specifically, 1E-12 m²/sec-1E-11 m²/see at room temperature.

Lithium-metal battery electrolyte 200 can comprise an electrolyte additive 250, e.g., metal salts (e.g., having bis(trifluoromethanesulfonyl)imide (TFSI), bis(fluorosulfonyl)imide (FSI), hexafluorophosphate (PF₆), tetrafluoroborate (BF₄), and/or bis(oxalate) borate (BOB) anions), phosphates, and the like. In some examples, lithium-metal battery electrolyte 200 comprises an electrolyte additive 250 selected from the group consisting of sodium bis(trifluoromethanesulfonyl)imide) (NaTFSI, leveling agent to promote smooth lithium plating), tris(trimethylsilyl)phosphate (TSP, CEI-forming additive to promote high voltage stability), lithium nitrate (LiNO3, SEI-forming additive for enhanced lithium passivation and lithium conduction through SEI), magnesium nitrate (MgNO3, SEI-forming additive for enhanced lithium passivation and lithium conduction through SEI), lithium difluoro (oxalate) borate (LIDFOB, CEI-forming additive to promote high voltage stability), lithium difluorophposphate (LiPF2O2, CEI-forming additive to promote high voltage stability), lithium bis(oxalate) borate (LiBOB, CEI-forming additive to promote high voltage stability), and fluoroethylene carbonate (FEC, SEI-forming additive to promote LiF-rich, strongly passivating SEI). In some examples, the lithium-metal battery electrolyte 200 comprises 0-5%, 0-3%, or even 0.5-3% of electrolyte additive 250 by weight.

### Examples of Methods of Fabricating Lithium-Metal Rechargeable Electrochemical Cells

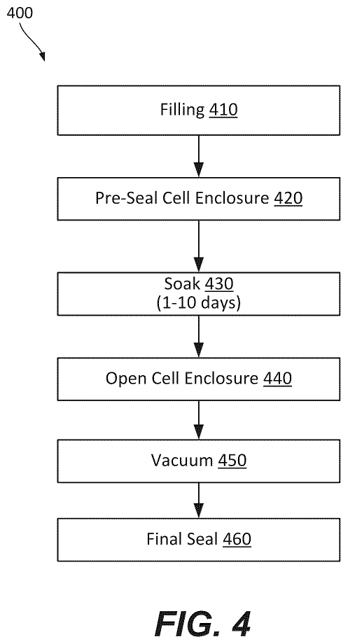

FIG. 4 is a process flowchart corresponding to method 400 of fabricating lithium-metal rechargeable electrochemical cell 100, in accordance with some examples. Method 400 may commence with (block 410) filling cell enclosure 102 (containing lithium-metal negative electrode 110, positive electrode 120, and separator 140) with lithium-metal battery electrolyte 200. Various examples of lithium-metal battery electrolyte 200, positive electrode 120, and other cell components are described above with reference to FIGS. 1 and 2.

Method 400 may proceed with (block 420) pre-sealing cell enclosure 102 while lithium-metal battery electrolyte 200 is allowed to soak into separator 140 and to some extent into positive electrode 120. The pre-sealing operation helps to reduce the evaporation of various components of lithium-metal battery electrolyte 200 and allows for extending the duration of the soaking operation.

Method 400 may proceed with (block 430) soaking lithium-metal rechargeable electrochemical cell 100 for a period (e.g., 1-10 days) while not undergoing any cycling conditions. This soaking operation ensures that lithium-metal battery electrolyte 200 soaks into separator 140 and to some extent into positive electrode 120 and provides ionic conductivity within lithium-metal rechargeable electrochemical cell 100 during the cell cycling.

Method 400 may proceed with (block 440) opening cell enclosure 102 and (block 450) vacuuming the interior of cell enclosure 102 or, more specifically, subjecting the interior of cell enclosure 102 to a reduced pressure to remove any bubbles from the lithium-metal battery electrolyte 200. The magnitude of the vacuum applied during vacuuming may be selected to effectively remove void-filling gas bubbles from the interior of the cell enclosure 102 and promote complete and homogeneous wetting of the lithium-metal negative electrode 110, positive electrode 120, and separator 140.

Method 400 then proceeds with (block 460) final sealing of cell enclosure 102.

### Application Examples

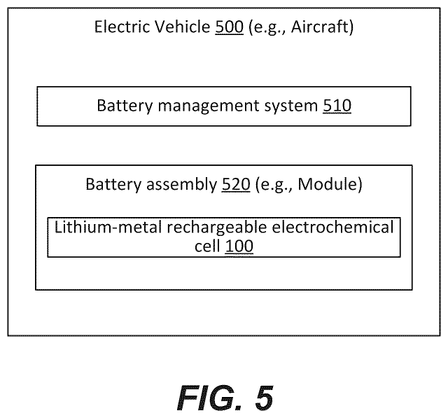

Lithium-metal rechargeable electrochemical cell 100 described herein, can be used for various applications, such as ground-based vehicles, boats, aircraft, and spacecraft. For example, aircraft and/or spacecraft use Li-metal batteries as such batteries have significantly higher gravimetric energy density than, e.g., Li-ion batteries. Both aircraft and spacecraft applications require lower mass cells, as additional mass leads to lower payload capacity. For these applications to utilize the maximum amount of their designed capacity, the energy system must be the lowest mass possible. In addition, safety is paramount in both of these applications, as onboard fires while in flight could be mission-critical and cause catastrophic failure of the system. In this scenario, occupants or personnel using the system are not able to simply depart from aircraft and/or spacecraft (e.g., in comparison to ground-based vehicles). FIG. 5 is a schematic block diagram of electric vehicle 500 (e.g., aircraft) comprising battery assembly 520, which in turn comprises one or more lithium-metal rechargeable electrochemical cell 100. Electric vehicle 500 also comprises battery management system 510, electrically and communicatively coupled to battery assembly 520.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. A lithium-metal battery electrolyte comprising:
a diluent having a formula CF₂H—(CF₂)ₙ—O—CH₂—(CF₂)ₘ—CF₂H where n and m are each separately 0-3; and
a core mixture comprising a set of salts and a set of solvents, wherein:
the set of salts comprises a salt having an anion bis(fluorosulfonyl)imide and an additional salt having an anion represented by R—SO₂—N—SO₂—R′,
each of R and R′ is selected from the group consisting of CF₃, C₂F₅, and C₃F₇,
a mole fraction (X3) of the salt in the set of salts in the core mixture is 0.5 or greater, and
the set of solvents comprises an ionic liquid and a molecular solvent.

2. The lithium-metal battery electrolyte of claim 1, wherein a mole fraction (X1) of the core mixture in the lithium-metal battery electrolyte is 0.4-0.99.

3. The lithium-metal battery electrolyte of claim 1, wherein a mole fraction (X2) of the set of salts in the core mixture is 0.25-0.55.

4. The lithium-metal battery electrolyte of claim 1, wherein a mole fraction (X4) of the ionic liquid in the set of solvents is 0.01-0.65.

5. The lithium-metal battery electrolyte of claim 1, wherein the diluent is 1,1,2,2-tetrafluoroethyl-2,2,3,3-tetrafluoropropyl ether (TFPE).

6. The lithium-metal battery electrolyte of claim 1, wherein each of R and R′ in R—SO₂—N—SO₂—R′ representing the anion of the additional salt is CF₃.

7. The lithium-metal battery electrolyte of claim 1, wherein the set of salts further comprises a salt having a different composition from the salt and the additional salt and selected from the group consisting of lithium tetrafluoroborate (LiBF4), lithium hexafluorophosphate (LiPF6), lithium bis(oxalato) borate (LiBOB), lithium difluoro (oxalato) borate (LiDFOB), lithium trifluoromethanesulfonate (LiTf), lithium nitrate (LiNO₃).

8. The lithium-metal battery electrolyte of claim 1, wherein the ionic liquid is selected from the group consisting of N-propyl-N-methylpyrrolidinium bis(fluorosulfonyl)imide (Pyr13FSI), N-butyl-N-methylpyrrolidinium bis(fluorosulfonyl)imide (Pyr14FSI), N-pentyl-N-methylpyrrolidinium bis(fluorosulfonyl)imide (Pyr15FSI), N-hexyl-N-methylpyrrolidinium bis(fluorosulfonyl)imide (Pyr16FSI), N-heptyl-N-methylpyrrolidinium bis(fluorosulfonyl)imide (Pyr17FSI), N-octyl-N-methylpyrrolidinium bis(fluorosulfonyl)imide (Pyr18FSI).

9. The lithium-metal battery electrolyte of claim 1, wherein the ionic liquid comprises N-propyl-N-methylpyrrolidinium bis(fluorosulfonyl)imide (Pyr13FSI) and at least one ionic liquid selected from the group consisting of N-butyl-N-methylpyrrolidinium bis(fluorosulfonyl)imide (Pyr14FSI), N-pentyl-N-methylpyrrolidinium bis(fluorosulfonyl)imide (Pyr15FSI), N-hexyl-N-methylpyrrolidinium bis(fluorosulfonyl)imide (Pyr16FSI), N-heptyl-N-methylpyrrolidinium bis(fluorosulfonyl)imide (Pyr17FSI), N-octyl-N-methylpyrrolidinium bis(fluorosulfonyl)imide (Pyr18FSI), wherein the mole fraction of N-propyl-N-methylpyrrolidinium bis(fluorosulfonyl)imide (Pyr13FSI) in the ionic liquid is greater than 0.75.

10. The lithium-metal battery electrolyte of claim 1, wherein the molecular solvent is selected from the group consisting of 1,2-dimethoxyethane (DME), 1,2-diethoxyethane (DEE), dimethoxymethane (DMM), 1,3-dimethoxypropane (DMP), dipropylether (DPE), dibutylether (DBE), bis(2-methoxyethyl) ether (G2, diglyme).

11. A lithium-metal battery electrolyte comprising:
a diluent having a formula CF₂H—(CF₂)ₙ—O—CH₂—(CF₂)ₘ—CF₂H where n and m are each separately 0-3;
a core mixture comprising a set of salts and a set of solvents; and
an electrolyte additive comprising tris(trimethylsilyl)phosphate, wherein:
the set of salts comprises a salt having an anion represented by R—SO₂—N—SO₂—R′,
each of R and R′ is selected from the group consisting of F, CF₃, C₂F₅, and C₃F₇, and
the set of solvents comprises an ionic liquid and a molecular solvent.

12. The lithium-metal battery electrolyte of claim 11, wherein a mole fraction (X1) of the core mixture in the lithium-metal battery electrolyte is 0.4-0.99.

13. The lithium-metal battery electrolyte of claim 11, wherein a mole fraction (X2) of the set of salts in the core mixture is 0.25-0.55.

14. The lithium-metal battery electrolyte of claim 11, wherein a mole fraction (X3) of the salt in the set of salts is 0.5 or greater.

15. The lithium-metal battery electrolyte of claim 11, wherein a mole fraction (X4) of the ionic liquid in the set of solvents is 0.01-0.65.

16. The lithium-metal battery electrolyte of claim 11, wherein the ionic liquid is selected from the group consisting of N-propyl-N-methylpyrrolidinium bis(fluorosulfonyl)imide (Pyr13FSI), N-butyl-N-methylpyrrolidinium bis(fluorosulfonyl)imide (Pyr14FSI), N-pentyl-N-methylpyrrolidinium bis(fluorosulfonyl)imide (Pyr15FSI), N-hexyl-N-methylpyrrolidinium bis(fluorosulfonyl)imide (Pyr16FSI), N-heptyl-N-methylpyrrolidinium bis(fluorosulfonyl)imide (Pyr17FSI), N-octyl-N-methylpyrrolidinium bis(fluorosulfonyl)imide (Pyr18FSI).

17. The lithium-metal battery electrolyte of claim 11, wherein the molecular solvent is selected from the group consisting of 1,2-dimethoxyethane (DME), 1,2-diethoxyethane (DEE), dimethoxymethane (DMM), 1,3-dimethoxypropane (DMP), dipropylether (DPE), dibutylether (DBE), bis(2-methoxyethyl) ether (G2, diglyme).

18. A lithium-metal rechargeable electrochemical cell comprising:
a lithium-metal negative electrode comprising a lithium-metal negative active material layer;
a positive electrode comprising a positive active material layer;
a separator positioned between the lithium-metal negative electrode and the positive electrode; and
a lithium-metal battery electrolyte comprising a diluent and a core mixture comprising a set of salts and a set of solvents, wherein:
the set of salts comprises a salt represented by R—SO₂—N—SO₂—R′,
each of R and R′ is selected from the group consisting of F, CF₃, C₂F₅, and C₃F₇, and
the set of solvents comprises an ionic liquid and a molecular solvent.

19. The lithium-metal rechargeable electrochemical cell of claim 18, wherein the lithium-metal negative active material layer is a standalone structure having a thickness of at least 10 micrometers and operable, at least in part, as a current collector of the lithium-metal negative electrode.

20. The lithium-metal rechargeable electrochemical cell of claim 19, wherein:
a mole fraction (X1) of the core mixture in the lithium-metal battery electrolyte is 0.4-0.99,
a mole fraction (X2) of the set of salts in the core mixture is 0.25-0.55,
a mole fraction (X3) of the salt in the set of salts is 0.5 or greater, and
a mole fraction (X4) of the ionic liquid in the set of solvents is 0.4-0.65.
